(19) United States
(12) Patent Application Publication
(10) Pub. No.: US 2022/0383733 A1
(43) Pub. Date: Dec. 1, 2022

(54) PEDESTRIAN TRAFFIC LIGHT WITH AUTONOMOUS ENERGY

(71) Applicant: Walter Rolando Galvez Rendon, Quindío (CO)

(72) Inventor: Walter Rolando Galvez Rendon, Quindío (CO)

(21) Appl. No.: 17/752,672

(22) Filed: May 24, 2022

(30) Foreign Application Priority Data
May 25, 2021 (CO) NC2021/0006906

(51) Int. Cl. G08G 1/005; H02S 10/20; H02S 20/10

(52) U.S. Cl. CPC G08G 1/005; H02S 10/20; H02S 20/10

(57) ABSTRACT

This invention is in the field of electricity and electronics, it focuses on reducing the risk of traffic accidents in people with visual or other disabilities who try to cross a road when there is no power or there is no one to guide them. To solve this problem, this device is proposed to be used in public spaces and roads. Characterized by a solar panel (3), some lamps (1), a mast (2) and housing (4) with sensors infrared, CCD, time of flight sensors, and mechanical sensors that are connected to the processor and connected to one audio output elements that gives spoken messages of risk to pedestrians, with energy autonomy and disconnected from the electricity grid.

### TECHNOLOGY SECTOR

It is related to electronic pedestrian traffic lights which operate in the electricity and electronics sector.

### PREVIOUS TECHNOLOGY

The Ministry of Transport of Colombia's road signs manual indicates that one of the reasons why traffic lights are installed is to avoid accidents and conflict between pedestrians, vehicles and cyclists who want to use the roads.

This risk of accident for which the traffic light was installed wanting to protect the pedestrian or cyclist, is revived when a traffic light that had already been installed to prevent to the pedestrians from being hit it out, is WITHOUT OPERATION because somewhere in the electrical chain there is a failure, either due to climate change, natural phenomena, or service failures and/or attacks on the electrical structure of the country. At the same time, power outages can be very short or for several hours or days, every minute of a traffic light off is an accident risk

There are normal pedestrian traffic lights that serve cyclists and pedestrians, those operate with conventional electricity, and require thousands of miles wiring, towers and several poles between the hydroelectric plants and the site where the traffic light operates so that pedestrians, bicycles, and vehicles can pass without having conflict between them, as well as risk of accidents, deaths, and injuries. Pedestrians and cyclists are the most vulnerable road users as victims of road accidents

When Bogotá or any other city turns off the traffic lights by any reason, this generates a multiple risk of accident every minute in more than one thousand intersections where pedestrians and cyclists circulate, this risk depends on the affectation of the electric fluid and the hundreds of kilometers of networks that make it possible for electricity to reach each traffic light. These networks of hundreds of kilometers require maintenance costs and the cost of electricity that must be paid for all traffic lights is considerable.

Pedestrians, who also are being vulnerable actors, because many have disabilities and/or require help to cross the intersection and even if the traffic light exists, they do not know how to use or interpret the light signals that it emits. For example, without knowledge people, who want to cross an intersection, do not know how the traffic light operates and cross the road at risk of being run over without someone explaining anything.

### DESCRIPTION OF THE INVENTION

This invention who is presented, is an improvement to the existing technology to give it technical advantages, a better use, save more lives, inform, and educate the pedestrian, mitigate effects of climate change on the life, health of pedestrians and cyclists, additionally to giving it this advantage, the governments do not have to pay electric energy that consume the traffic lights that already exist. Instead, it can be updated to the present invention with all the advantages and utilities that previous pedestrian traffic light technology does not have.

This autonomous pedestrian traffic light (10) invention proposes a traffic light that can operate with energy from renewable sources such as wind, thermal, solar, or electric piezo, both to update existing traffic lights and build from scratch new traffic lights. It can also detect pedestrians and talk to them, mitigating the risk of accidents due to lack of energy or lack of education in the use of the traffic light, inventions that may contain, among others, the following elements, and characteristics.

The invention contemplates among others to integrate a plurality of lamps (1) with diameters between 10 and 30 centimeters that can be totally circular or with polygon-like edges between them the dodecagon and the square, lamps (1) that emit light in a plurality of colors, which operate at voltages between 3 Volts and 40 Volts DC in pulses or in AC and that are arranged facing the tracks, to sidewalks or pedestrian crossings on one or more metal or plastic masts (2) with or without arm measuring between 2 to 9 meters in height and 2 to 25 centimeters in diameter that can be totally circular or with polygon type edges including the dodecagon and the square, the mast (2) supports a solar panel (3) and at a lower height than the solar panel (3) are the traffic light lamps (1) that can be a plurality around the mast (2) oriented to signal to several sides both vehicular and pedestrian type, with consumption between ⅛ watt and 8 watts each lamp (1), which are connected to an electronic circuit (6) electrically connected to a battery (5) that is recharged with energy from renewable sources such as a solar panel (3), thermal energy, wind or electric piezo. It can also operate hybridly with grid power to charge batteries or give direct power to electronic components and use renewable energy to reduce consumption or serve as support when grid power fails. But without abandoning that the main purpose and the most important technical advantage that arises is the totally autonomous operation reducing to zero the consumption of the electrical network and without the need to consume energy from the network.

In this invention are used a plurality of lamps (1) that have one or more LEDs (light emitting diodes) (9) that can emit light of one or several colors simultaneously and are organized in Cartesian or polar matrix with distance between LEDs (9) in each lamp (1) when using more than one LED (9) in ranges from 1 millimeter to 30 centimeters and with a thickness of LED (9) lamp between 1 millimeter and 2 centimeters, with the energy produced by the solar panel (3) and/or any of the other energy sources can operate both pedestrian traffic light lights and those of vehicles located in the same structure where the mast (2) is with the solar panel (3) or in other nearby structures giving energy to other equipment.

It also contemplates one or a plurality of solar panels (3) with ranges between 5 and 300 watts of power and 3 volts at 40 volts DC, placed on one or a plurality of masts (2) or configurations of these.

This invention also incorporates the electronic circuit (6) which operates in voltage ranges from 3 Volts to 40 volts DC which incorporates a processor (8) connected to a communications module (7) that allows data sharing and coordinated operation between several devices.

The lamps (1) have LEDs (9) that are connected to the electronic circuit (6) with a processor (8) that manages the ignition and shutdown of the entire lamp (1) or some LEDs (9) of the lamp (1) individually in time intervals, the processor (8) is also connected to the pins of the LEDs (9) that activate the color emitted by each LED (9) or groups of LEDs (9) in time intervals generating alphanumeric patterns or figures that change over time.

It also incorporates vibration and sound devices that can vibrate the traffic light, accessories or tiles or floor near the side of the traffic light to indicate to the disabled operating times or when to pass according to the vibration pattern.

The circuits (6), lamps (1) and batteries are located inside the housing (4) where the pedestrian or vehicle traffic light lamps (1) are housed, or the battery (5) and electronic circuits (6) can also be located in an external metal or plastic housing (4) connected to the solar panel (3), from where the power supply cables for the lamps (1) located on the same mast (2) come out, on a mast arm or in another structure. With solar energy, this pedestrian traffic light can generate Wi-Fi networks at the intersection for public internet or smart city applications to communicate data in real time.

The electronic circuits (6) incorporate optical (11), infrared (12), CCD (charge-coupled device) (13), lidar (14), touch, infrared time of flight sensors (15) and mechanical sensors (16) that are connected to the processor (8) which in turn is connected to one audio output element (17) that gives spoken messages to pedestrians.

Communication and internet connectivity to inform or receive orders to remote site or from remote site, uses technologies such as tcp ip, tcp, udp or through web services such as http to know if the system is operating well, is being sabotaged, is being opened its elements through scheduled maintenance or if it is subject to theft and sabotage etc., information that can be communicated in real time to make decisions or to communicate with other devices through IoT and technologies such as lora, wifi gprs among others.

With IoT devices, traffic lights can also send messages to mobile devices of pedestrians with disabilities informing them of the status of the traffic light and how to use it or alerts so that they can cross the road of audible, visual or vibration type of the device or produced by the traffic light.

### Problem Exposed for the Development of This Invention

The problem is the need for technical improvements to a traffic light that mitigates the risk of accidents due to lack of energy or lack of education or information of pedestrians or cyclists when using it in addition to suppressing the payment for energy consumption of the electricity grid and mitigating the effects of climate change on the lives of people on the roads when energy is affected.

### To Solve the Problem Exposed

A traffic light is proposed that operates with lamps (1) with diameters between 10 and 30 centimeters that can be totally circular or with low consumption polygon type edges of ⅛ watt to 8 watts in ranges from 3 to 40 volts, between 1 millimeter to 2 centimeters wide that are fixed to a mast (2) or mast arm, the mast (2) of diameter between 2 to 25 centimeters and height between 2 to 9 meters, lamps (1) connected to a circuit (6) and a battery (5) that is powered by renewable energy such as solar panels (3) or other renewable sources so that the traffic light does not require energy from the electricity grid and can also communicate messages to pedestrians through sensors to detect pedestrians and audio outputs to tell them how to use the traffic light in addition to serving the pedestrian traffic light of public access to the internet.

### Application Example

In an existing pedestrian traffic light that is powered by conventional electrical network, one or more solar panels (3) are placed on a mast (2) or the mast arm. Inside the housing (4) of existing pedestrian and/or vehicular traffic lights are located the circuits (6), the small battery (5), and the lamps (1) in the cabin for lamps according to the color. In case the battery (5) and circuits (6) do not fit in the traffic light housing (4) behind the lamps (1), the battery (5) and circuits (6) can also be located in a plastic or metal housing (4) secured to the mast (2) or its arm. Sensors and audio or vibration devices that detect and speak to pedestrians can also be in the pedestrian traffic light housing (4) or a separate housing (4).

The solar panel or panels (3) of 300 watts or less, produce the energy for daily operation with daylight without the need for direct sun generate 10% of its capacity at low solar luminosity i.e. 30 watts that are enough to give energy to all the elements of the intersection of existing traffic lights including controller, sensors, communication elements, audio devices lights that are very low consumption and high efficiency that are below 2 watts of consumption the most ideal so that everything can be autonomous with solar energy, since all the elements mentioned above for an average intersection of groups consume in their entirety less than 15 watt hours with all these elements. The additional energy produced every hour in excess by the solar panel (3) that corresponds to 15 watts when there is low radiation or 285 watts when there is full sunlight on the panel (3), accumulates in the battery (5) for night operation, being able in a single hour of radiant sun a day to accumulate the energy for operation at night, at night the consumption decreases by half or less than half because the system decreases the brightness of the LEDs (9) and turns off the audio devices and sensors when it notices that there are no people circulating. So, the energy stored on some days of the week of good solar radiation even serves to operate several days without sunlight with a small battery (5). The traffic light can send alerts when the power load is not sufficient and/or disconnect elements that are not essential to operate in basic mode without sensors, communications, and sound, reducing its electricity consumption to less than 8 watts so as not to discharge the battery (5) at night.

Even without a battery or with a battery in poor condition, this traffic light can operate with all its components during the daylight hours between 6 in the morning and 6 in the afternoon in the hours of greatest activity on the streets. Part of the success of this is that a 1 watt lamp (1) replaces LED (9) lamps that consume 10 times more such as those of 10 or 12 watts LED of current technology that operate at 120 volts AC or incandescent lamps 1 of more than 50 watts at 120 volts AC. In addition to the sensors and audio elements are also very low consumption so all the elements of the traffic light including all its lights consume almost the same as a single one of the 12-watt LED lamps that operate at 120 volts AC and that to operate with solar energy would need large banks of batteries and a very large amount of solar panels (3) to ensure more than 400 watts of energy every hour which may require an intersection with pedestrian traffic lights at 120 volts AC, versus an intersection of between 8 to 15 watt hours autonomously operating on energy from the sun.

This energy saving of more than 400 watts every hour for the next 100 years moving to autonomous traffic lights with the sun, make the pedestrian traffic light a sustainable business model that produces return on investment for the non-payment of energy bills in the future, while saving lives and mitigating the risk of accidents when there is no power from the grid, in addition to a positive impact on the environment and educating pedestrians and cyclists. Technical advantages and benefits provided by this invention.

Another example of application is to use it at intersections of traffic lights that do not have pedestrian traffic lights, putting the elements such as battery (5), circuits (6), mast (2) with or without arm, solar panel (3) and high efficiency lights inside the passenger compartment of the vehicular traffic light as well as sensors, or housing these elements in a plastic or metal housing (4) of a plurality of ways, in this way those traffic lights can be autonomous with solar energy, as a plus can also put the rest of the system that although it is not indispensable is a good accessory, it can speak to the pedestrian even if it has specifically a traffic light for pedestrians, they can tell pedestrians and cyclists when they can cross safely and/or other information in addition to sending data to the internet or other devices all autonomous with energy from the sun and without having to invest money in buying the pedestrian part.

Another application is the implementation from scratch of pedestrian traffic lights in corners or pedestrian crossings where there are still no traffic lights, there the same process of the previous application is repeated but a small civil work is required to install the mast (2) with or without arm on the sidewalk of a road, with the advantage that there is no need to do works to bring the electrical connection to the point of the traffic light, nor is there any making ducts and crossing with cables the tracks for electrical connections and carrying energy. This saves large costs and interventions that affect vehicular traffic, thus reducing implementation costs and implementation time.

One of the advantages for maintenance is to reduce costs by more than 50% since these traffic lights fail less and require fewer spare parts, most of the failures and damages of the traffic lights are produced by the same electrical network that by fluctuations rises, drops in voltage and continuous cuts affects the electronic equipment that are very expensive. while solar power at the DC level does not make those fluctuations or ever produce high voltages and is therefore more reliable, less expensive operation and maintenance.

Maintenance is even easier because the traffic light can practically speak through the audio devices and say what is the technical problem that causes it, data that can also be transmitted in real time to maintenance managers so that they can visualize in their mobile equipment in real time the failures, problems, or data that the traffic light sends them.

### DESCRIPTION OF THE FIGURES

FIG. 1: It shows the perspective drawing of the invention (10) implemented in a corner of a road, where a mast (2) is seen at the top of the mast a solar panel (3), attached to this mast some pedestrian traffic lights (1) and a housing (4) in which battery (5) and electronic circuits (6) are put alternatively.

FIG. 2: Is a diagram illustrating interaction between solar panel (3), battery (5), at least one lamp (1), communication module (7), and electronic circuits (6).

FIG. 3: Is an exemplary block diagram illustrating the connection of the communication module (7), the electronic circuits (6), the at least one lamp (1) including light emitting diodes (LEDs) (9)

FIG. 4: Is a block diagram of electronic circuits shown in FIG. 3. The electronic circuits (6) having optical sensor (11), infrared sensor (12), charge-coupled device (13), lidar sensor (14), infrared time of flight sensor (15), mechanical sensor (16) all connected to a processor (8) connected to an audio output element (17).

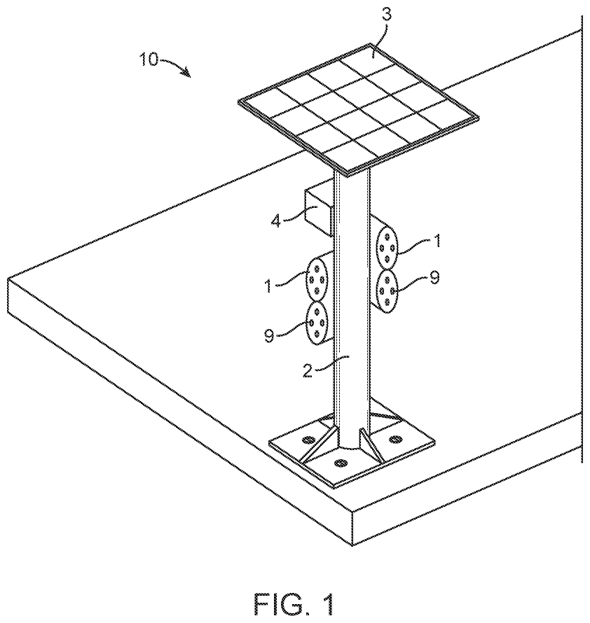

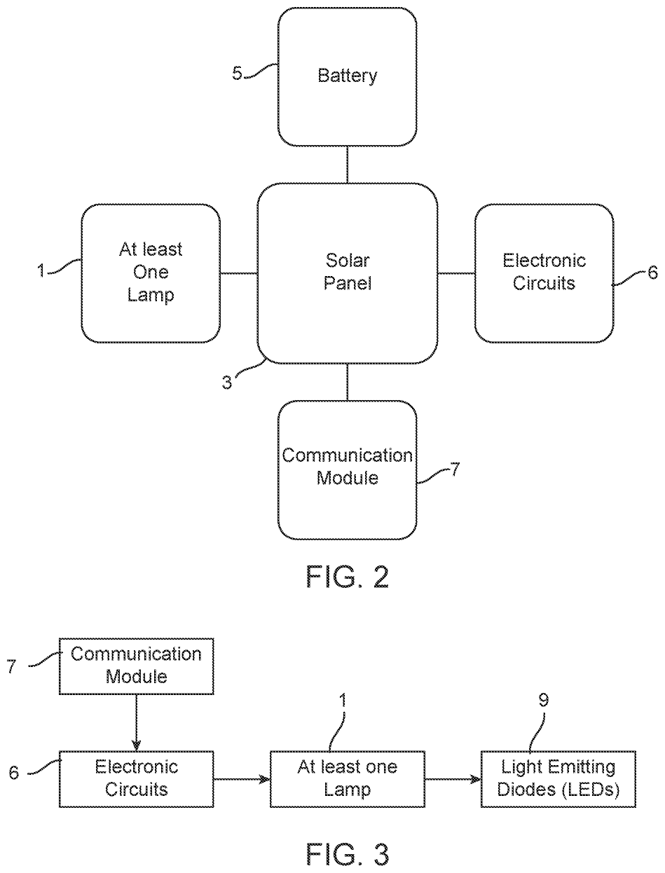

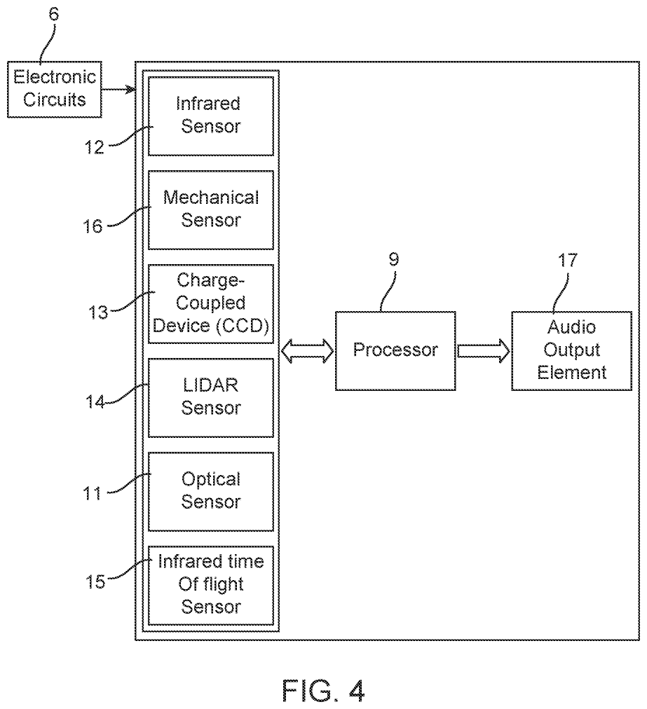

### BEST WAY TO REALIZE THE INVENTION

This invention is made by putting a metal or plastic mast (2) on a sidewalk or mast (2) with or without arm with height between 2 to 9 meters and 2 to 25 centimeters in diameter that can be totally circular or with polygon type edges including the dodecagon and the square, at the top of the mast (2) or arm a solar panel (3) is placed and secured with a plurality of means of grip such as screws, pins or guayas. From the solar panel (3) a cable is connected to the pedestrian traffic lights where the electronic circuit (6), audio, sensors and battery (5) are located and in the front are the lamps (1) that emit light in a plurality of colors, which operate at voltages between 3 Volts and 40 Volts DC in pulses or in AC and that are arranged facing the tracks, to sidewalks or pedestrian crossings, if the batteries do not fit in the traffic light housing (4), an external housing can be used to put batteries and circuits (6) there. Electrical connections are made to the previously charged battery (5) and between the components and a traffic light is ready that can operate autonomously with solar energy and with additional accessory functions such as talking to pedestrians and transmitting information among others. Being able to operate as an accessory but not indispensable in a hybrid way with energy from the grid to charge the batteries or give direct energy to the electronic components and use renewable energy to reduce consumption or serve as support when the grid power fails. But without abandoning that the main purpose and the most important technical advantage that arises is the totally autonomous operation reducing to zero the consumption of the electrical network and without the need to consume energy from the network.

1) A pedestrian traffic light with autonomous energy which is characterized by comprising at least one housing (4) powered by a solar panel (3) supplying power to a battery (5), electronic circuits (6), a communication module (7) and at least one lamp (1) with voltages between 3 and 40v DC embedded inside at least one module of traffic light that is attached to a mast (2), mast with length between 2 to 9 meters in height and 2 to 25 centimeters in diameter of the mast that can be totally circular or with multiple polygon typefaces including a dodecagon shape and a square shape, the mast (2) is hoisted with an end of the mast (2) fixed to a ground, said mast (2) can have a curved part and has fastened on its surface the housing (4) and also on the mast (2) has fixed on its surface at least one solar panel (3), the at least one lamp (1) and housing (4) are arranged on the mast (2) under the solar panel (3) that provides direct current energy in ranges between 3 and 40v DC, with energy autonomy and disconnected from an electricity grid.

2) The pedestrian traffic light with autonomous energy set forth in claim 1, wherein said the electronic circuits (6) are connected to said communications module (7) to allow internet sharing, data and coordinated operation between several devices, with a voltage between 3- and 40v DC and a total power of between ⅛ watt and 50 watts in DC operate the electronic circuits (6), said at least one lamp (1) and said communication module (7), autonomously energetically with energy generated by the solar panel (3).

3) The pedestrian traffic light with autonomous energy set forth claim 1, wherein said at least one lamp (1) has light emitting diodes (LEDs) (9) that are connected to the electronic circuits (6) with a processor (8) that manages the ignition and shutdown of said at least one lamp (1) or predetermined LEDs (9) thereof individually in time intervals, the processor (8) is configured to be connected pins of the LEDs that activate the color emitted by each of said LEDs or groups of LEDs in time intervals generating alphanumeric patterns or figures that change over time.

4) The pedestrian traffic light with autonomous energy, set forth in claim 1, wherein said electronic circuits (6), said at least one lamp (1), and said battery (5) in another realization can be contained inside the pedestrian traffic light with autonomous energy, wherein said at least one lamp (1) is housed or the battery (5) and said electronic circuit (6) are configured to also be in an external housing connected to the solar panel (3), from where power supply cables for the at least one lamp located on the mast (2) or in another structure thereof.

5) The pedestrian traffic light with autonomous energy, set forth in claim 1, wherein said electronics circuit (6) comprises an optical sensor (11), an infrared sensor (12), a charge-coupled device (CCD) (13), lidar sensors (14), infrared time of flight sensors (15) and mechanical sensors (16) that are connected to the processor (8) which in turn is connected to an audio output element (17) configured to give spoken messages to pedestrians.
